(19) United States
(12) Patent Application Publication
(10) Pub. No.: US 2019/0312715 A1
(43) Pub. Date: Oct. 10, 2019

(54) Network Communication Method

(71) Applicant: PEPPERL + FUCHS GMBH, Mannheim (DE)

(72) Inventors: Steffen Graber, Mannheim (DE); Dirk Ziegelmeier, Mannheim (DE)

(21) Appl. No.: 16/381,993

(22) Filed: Apr. 11, 2019

Related U.S. Application Data
(63) Continuation of application No. PCT/EP2018/072806, filed on Aug. 23, 2018.

(30) Foreign Application Priority Data
Aug. 29, 2017 (GB) 1713789.4

(51) Int. Cl. H04L 5/14; H04L 25/49; H04B 3/14; H04B 3/20

(52) U.S. Cl. CPC H04L 5/143; H04L 25/4923; H04L 5/1461; H04B 3/142; H04B 3/20; H04L 25/4925

(57) ABSTRACT

There is provided a method for supporting full duplex communication between a local PHY and a remote PHY via a single balanced pair of conductors. The method comprises for each PHY receiving a binary data stream and converting the binary data stream into a ternary symbol stream, wherein the conversion comprises:
converting each nibble of the binary data stream directly into one respective triplet of ternary symbols for the ternary symbol stream, and
limiting a maximum allowed number of consecutive positive symbols or consecutive negative symbols of the ternary symbol stream to 5 symbols or less.

### CROSS-REFERENCE TO RELATED PATENT APPLICATIONS

This patent application is a continuation of International Application No. PCT/EP2018/072806, filed Aug. 23, 2018, which claims the benefit of Great Britain Patent Application No. 1713789.4, filed Aug. 29, 2017, the entire teachings and disclosure of which are incorporated herein by reference thereto.

### FIELD OF THE INVENTION

The present invention relates to a network communication method, for example for use in an Ethernet system.

### BACKGROUND OF THE INVENTION

Ethernet networks typically comprise a plurality of devices connected to one another by network cabling. Ethernet devices transmit data packets that are addressed to specific devices on the network to enable data communications, for example as defined in various IEEE standards pertaining to Ethernet networks.

Each network cable is terminated to a PHY at one end of the cable, and another PHY at another end of the cable. The PHY comprises circuitry corresponding to the physical layer of the OSI 7-layer model for network communications, as will be apparent to those skilled in the art.

Conventionally, an Ethernet PHY comprises a Media Independent Interface (MII) for binary data communications with the higher layers (i.e. data link layer) of the OSI 7-layer model, a Physical Coding Sub-layer (PCS) for coding the symbols to be transmitted on the network cable, and a Physical Medium Attachment Sub-layer (PMA) with a Medium Dependent Interface (MDI) for transmitting the symbols on the network cable.

The transmitted symbols are defined according to the modulation format, and the conversion of the binary data from the MII into the symbols for transmission on the network cable typically comprises inserting extra symbols to help synchronize the communications between the two PHYs.

It is also possible for the network cable to be replaced by circuit board conductors, for example a backplane circuit board may provide a pair of conductors that connect PHYs of two daughter boards to one another, the backplane circuit board performing the role of the network cable.

U.S. Pat. No. 7,835,389 discloses an Ethernet PHY where a 4-bit packet stream is re-formatted into a 3-bit packet stream, and the 3-bit packet stream is converted into first and second ternary bit streams, for sending using PAM-3. A ternary bit may take values of −1, 0, or +1, and PAM-3 is a 3-level pulse amplitude modulation format for transmitting ternary bits (symbols), as will be apparent to those skilled in the art. Each 3-bit packet is converted into a pair of ternary bits. Since each 3-bit packet allows for 2\hat{ }3=8 combinations, and each corresponding pair of ternary bits allows for 3\hat{ }2=9 combinations, the redundant 9th combination in the pair of ternary bits is used for control codes.

This coding is efficient, however there is a desire to provide a PHY which has an improved range and/or maximum data rate, relative to cost and physical size requirements. It is therefore an aim of the invention to provide an improved PHY.

### SUMMARY OF THE INVENTION

According to an aspect of the invention, there is provided a method for supporting full duplex communication between a local PHY and a remote PHY via a single balanced pair of conductors. The method comprises for each PHY receiving at a Physical Coding Sublayer (PCS) of the PHY a binary data stream from a Medium Independent Interface (MII) of the PHY, converting the binary data stream into a ternary symbol stream within the PCS, and providing the ternary symbol stream to a Physical Medium Attachment Sublayer (PMA) of the PHY for transmission of the ternary symbol stream over the balanced pair of conductors. The conversion comprises:

converting each nibble of the binary data stream directly into one respective triplet of ternary symbols for the ternary symbol stream, and

limiting a maximum allowed number of consecutive positive symbols of the ternary symbol stream to 5 symbols or less, and/or limiting a maximum allowed number of consecutive negative symbols of the ternary symbol stream to 5 symbols or less.

Low signal frequencies can result when a long series of positive symbols or a long series of negative symbols is transmitted, since the frequency with which the symbols change becomes much lower than the symbol rate. Accordingly, the invention proposes a method in which the maximum allowed number of consecutive positive symbols or consecutive negative symbols of the ternary symbol stream is limited to 5 symbols or less, so that there will be more regular changes in the values of the symbol stream, and the bandwidth of the signal is reduced at its lower end to avoid low signal frequencies. The ternary symbol stream may consist of symbols having a value of either +1 (positive), 0, or −1 (negative). If a Pulse Amplitude Modulation (PAM) scheme is used, then the positive symbol is represented by a positive differential voltage pulse and the negative symbol is represented by a negative differential voltage pulse.

A balanced pair of conductors comprises two conductors which are electrically the same as one another, i.e. which have similar electrical length and impedance. A conductor's impedance varies depending on frequency, and typical Ethernet network cables have a complex characteristic impedance at relatively low signal frequencies, for example less than 500 kHz. The complex component of the characteristic impedance can lead to additional signal disturbances. Specifically, if the characteristic impedance of the balanced pair of conductors in a cable does not match the input impedance of the PHY, then signal reflections result, using up part of the noise immunity of the system. The signal reflections may for example be handled by an adaptive Echo Canceller of the PHY, and as the output of the Echo Canceller gets worse under a high amount of reflections, the eye (of an eye diagram) at the slicer is less open and therefore there is less margin for additional noise. This increases the cost and complexity of the echo canceller and the analogue-to-digital converter, as a higher dynamic range is required, and/or the maximum range over which the signal can be reliably transmitted is reduced.

The coding of ternary symbols taught in U.S. Pat. No. 7,835,389 is efficient, however a PAM-3 signal when encoded according to these rules, leads to a relevant amount of signal energy within a lower frequency range than when using the encoding of the present invention. The avoidance of low signal frequencies according to the present invention means that the lower cut-off frequency of the band-pass filter that is used to filter the received signal can be increased to compared to the previously known coding. This reduces the susceptibility of the system to noise from external noise sources within the range over which the lower cut-off frequency has been increased. For signals having a data rate of 5-20 Mbps, this is particularly advantageous because the range over which the lower cut-off frequency has been increased covers strong noise sources such as emissions from switch-mode power converters, which typically run at frequencies up to 100 kHz. For example in the case of a 10 Mbp/s (7.5 MSymbols/s) data rate signal, limiting the symbol stream to a maximum of five consecutive equal-valued symbols limits the data signal to frequencies above 200 kHz, allowing noise emissions from switch-mode power supplies (or similar switched devices, inverters for electronic motor speed control, or switchgear) to be effectively filtered out.

This avoidance of low frequencies allows the communication between the local and remote PHYs to be run at longer distances over comparable noise conditions, for example at a data rate of 10 Mbps in full duplex a network cable connecting the local and remote PHYs can extend at least a kilometre long.

If there is a continuous data stream coming from the MII interface, the data may first be scrambled, such as by using a linear feedback shift register (LFSR) to generate a pseudo random sequence which is XOR'ed with the continuous data stream from the MII interface. This provides a pseudo random datastream, which is then encoded into ternary symbols. Using a pseudo random datastream allows the descrambler to be synchronised to the scrambler at the receiver of the ternary symbols, allowing descrambling of the pseudo random datastream and recovery of the original datastream (which would not be possible by a pure random datastream).

Preferably, the ternary symbol stream is continuously provided to the PMA, even when user data is not being transmitted by the PHY, to maintain the network link between local and remote PHY's by sending idle data. The binary data stream may be scrambled before conversion into the ternary symbol stream. The scrambler in the transmit path of each PHY may be set with different values to the scrambler in the transmit path of the other PHY, to provide statistically independent data streams for both PHYs. Then, the transmitted data streams can be distinguished from one another at each PHY to allow separate training of the echo canceller and equaliser of the PHY. If the scramblers are implemented as linear feedback shift registers, then the different values of the scrambles may be set by using different polynomial(s) for the feedback loop(s) of the shift register(s), as will be apparent to those skilled in the art.

Each PHY may comprise a descrambler to descramble the scrambled data from the other PHY, and the idle data may be used to synchronise the descrambler to the scrambler of the other PHY. The polarity of the signal received from the other PHY may be determined by attempting to synchronize the descrambler, and if a descrambler lock is not reached within a predetermined period of time, reversing the polarity of the signal.

Since each nibble of the binary data stream provides 2\hat{ }4=16 possible combinations, and each triplet of ternary symbols provides 3\hat{ }3=27 possible combinations, there are 27−16=11 redundant combinations which can be used to prevent long strings of symbols having the same value as one another from being sent, even if the binary data stream has the same value for a long period of time.

Preferably, the redundant combinations are used in a manner that minimises the running disparity between the positive and negative symbols, so that the total number of positive symbols roughly matches the total number of negative symbols. This can help to keep the signal on the pair of conductors in equilibrium about a DC level rather than becoming unbalanced. In one example, 6 of the 16 binary nibbles are coded into triple ternary symbols that have no overall DC bias where the number of +1's in the ternary triplet equals the number of −1's in the ternary triplet, and the other 10 of the 16 binary nibbles are coded into a first set of 10 triple ternary symbols each having more +1's than −1's, and a second set of 10 triple ternary symbols each having more −1's than +1 s. For each one of those 10 binary nibbles, the corresponding triple ternary symbols are selected from either the first set or the second set depending on the running disparity, to keep the running disparity close to zero. The triple ternary symbol (000) may be used as an escape sequence for signalling to the receiver.

One use of the idle data may be to communicate information on a status of a receiver of the local PHY to the remote PHY, the information signalling whether the PHYs need to be retrained. PHYs typically require training of their equalisers when the network link is first set up, and may require training intermittently thereafter, as will be apparent to those skilled in the art.

Another use of the idle data may be to communicate information on a status of a transmitter or receiver of the local PHY to the remote PHY, the information providing an idle or wake indication for implementing Energy Efficient Ethernet (EEE).

To help distinguish between the user data and the idle data, stream delimiters may be inserted into the ternary symbol stream after the conversion, for example a start delimiter (SSD) that is inserted before the start of the user data, and an end delimiter (ESD) after the user data. The end delimiter may be used to signal whether the MII has signalled a communication error, by sending an end delimiter with error (ERR_ESD) if an error has occurred.

Preferably, the stream delimiters are inserted into the ternary symbol stream by replacing some of the ternary symbols that are converted from the binary data stream. For example, the end delimiter may replace part of the interframe sequence that is normally sent after each Ethernet data telegram, and the start delimiter may replace part of the preamble that is normally sent at the beginning of each Ethernet data telegram.

To improve resistance to errors, the stream delimiters may be represented by a sequence of symbols that is so different from the other allowed sequences of symbols that it can still be recognised even if one of the symbols of the stream delimiter is corrupted to another value. Each stream delimiter may be prefaced by an escape sequence, to provide a clear indication to the receiving PHY that the following symbols relate to a stream delimiter. Optionally, the escape sequence may exceed the maximum allowed number of symbols having the same value as one another in the conversion step, for example by consisting of six symbols each having a zero value, to provide a clear indication to the receiving PHY that a stream delimiter is about to be received. Alternatively, the escape sequence may only comprise three successive ternary symbols all having the value of zero, to avoid introducing any lower frequency components into the signal.

The PCS of each PHY may convert the binary data stream received from the MII, into the ternary symbol stream for transmission by the PMA to the other PHY. The PCS of each PHY may also convert a further ternary symbol stream that is received from the other PHY, into a further binary data stream, that is sent to the MII. Accordingly, the PCS and PMA of each PHY enable full duplex communication between the PHYs, via the balanced pair of conductors of the network cable.

Preferably, each ternary symbol has a value of −1, 0, or +1, and the PMA of each PHY modulates the ternary symbol onto the pair of conductors as differential data. Optionally, the differential data is modulated onto a direct current power signal, so that power can be delivered to remote devices. In common Ethernet terminology, the device supplying the power is typically referred to a Power Sourcing Equipment (PSE), and the device receiving the power is typically referred to as a Powered Device (PD), as will be apparent to those skilled in the art.

Each PHY may be connected to the balanced pair of conductors by reactive impedances (e.g. transformer coupling, capacitive coupling) for transmitting the ternary symbol stream on the balanced pair of conductors. Power circuitry of the device that comprises the PHY may be connected to the balanced pair of conductors by reactive impedances, for sending/receiving power to/from the device of the other PHY. The reactive impedances isolate the power source from the data being sent on the balanced conductors.

Preferably, the device sends the power and signal on the balanced pair of conductors in compliance with the IEC60079-11, Ed. 6 standard for intrinsic safety, so the network can be installed in hazardous areas. The range of at least 1 km at a data rate of 10 Mbps can even be achieved in powered applications conforming to intrinsically safe requirements. The power is connected to the pair of balanced conductors via an inductive impedance, and the signals are connected to the pair of balanced conductors via capacitive impedances, in effect modulating the power with the signals. For intrinsic safety, the inductors are diode-clamped with one or more standard diodes or a zener diode to limit the back e.m.f (electro-motive force), as will be apparent to those skilled in the art.

The reduction of low frequency signal components by avoiding transmitting long sequences of positive or negative symbols, allows a higher transmit amplitude to be used within the boundaries required to provide intrinsic safety. The higher transmit amplitude leads to a higher noise immunity, and increased ability to send data over long distances at comparable noise conditions. Normally, once a positive or negative voltage representing a positive (+1) or negative (−1) symbol has been coupled onto the balanced pair of conductors, the voltage on the conductors droops exponentially towards to the power voltage, until a transition in the value of the symbol occurs. Limiting the number of consecutive positive or negative symbols to 5 symbols or less, limits the amount of droop that can occur, and so when a transition to a new symbol occurs, the voltage on the conductors will not overshoot by as much as it otherwise would. Since there is less overshoot or bias on the signalling voltage, the signalling voltage can be increased to help extend range.

It is also possible to reduce the values (and therefore the physical sizes) of the inductors and capacitors used to couple the power and signal to the pair of balanced conductors, due to the removal of the lower frequencies by limiting the number of consecutive positive or negative symbols to 5 symbols or less. By removing those lower frequencies, the inductor does not need to be so large as to prevent those lower frequencies from shorting through into the low-impedance power supply, and the capacitor does not need to be so large as to couple those lower frequencies onto the pair of balanced conductors.

### DETAILED DESCRIPTION

Embodiments of the invention will now be described by way of non-limiting example only and with reference to the accompanying drawings, in which:

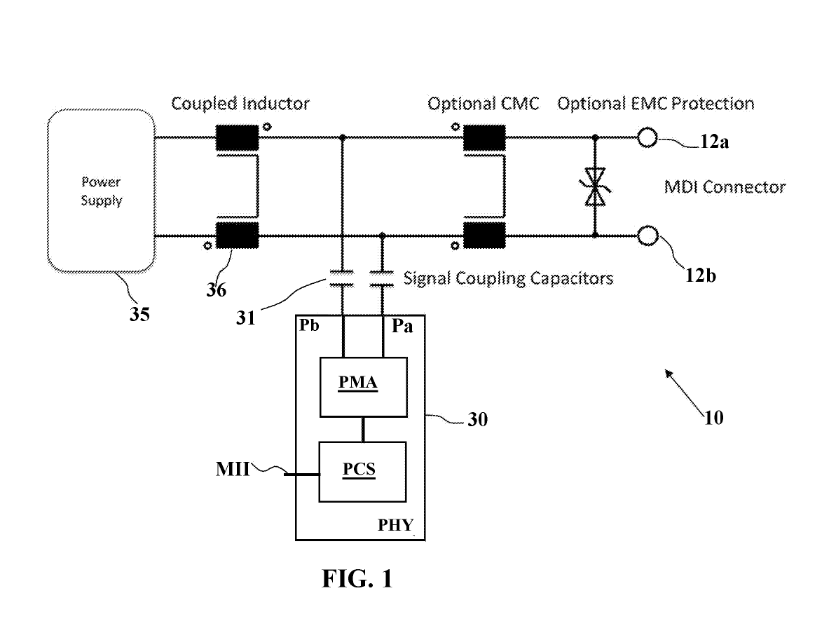

FIG. 1 shows a schematic diagram of a network port comprising a PHY according to an embodiment of the invention;

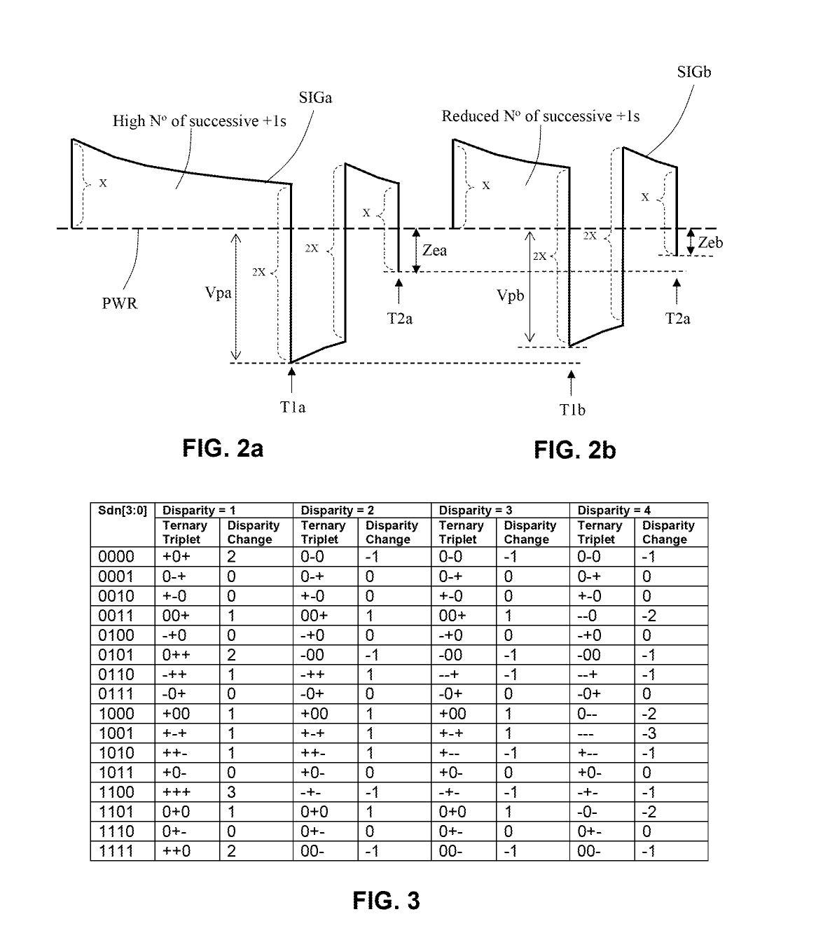

FIG. 2a shows a schematic diagram of a signal voltage across the terminals of the network port of FIG. 1 when transmitting a long sequence of +1 symbols;

FIG. 2b shows a schematic diagram signal voltage across the terminals of the network port of FIG. 1 when transmitting a shorter sequence of +1 symbols;

FIG. 3 shows a table of one possible triple ternary symbol encoding scheme according to an embodiment of the invention;

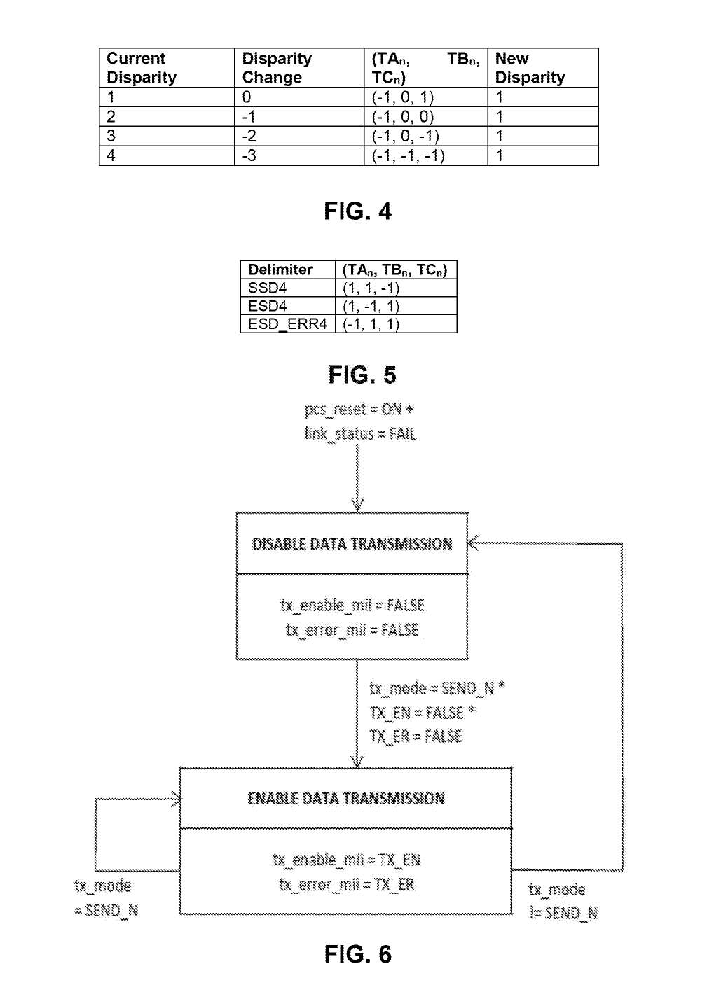

FIG. 4 shows a table of the values of a triple ternary symbol that is used to reset the running disparity of the ternary symbol stream;

FIG. 5 shows a table of the values of triple ternary symbols that may be used as delimiters for the beginnings and ends of user data transmission, according to an embodiment of the invention;

FIG. 6 shows a state diagram for the PCS of the PHY, governing the transmission of user data from the PHY;

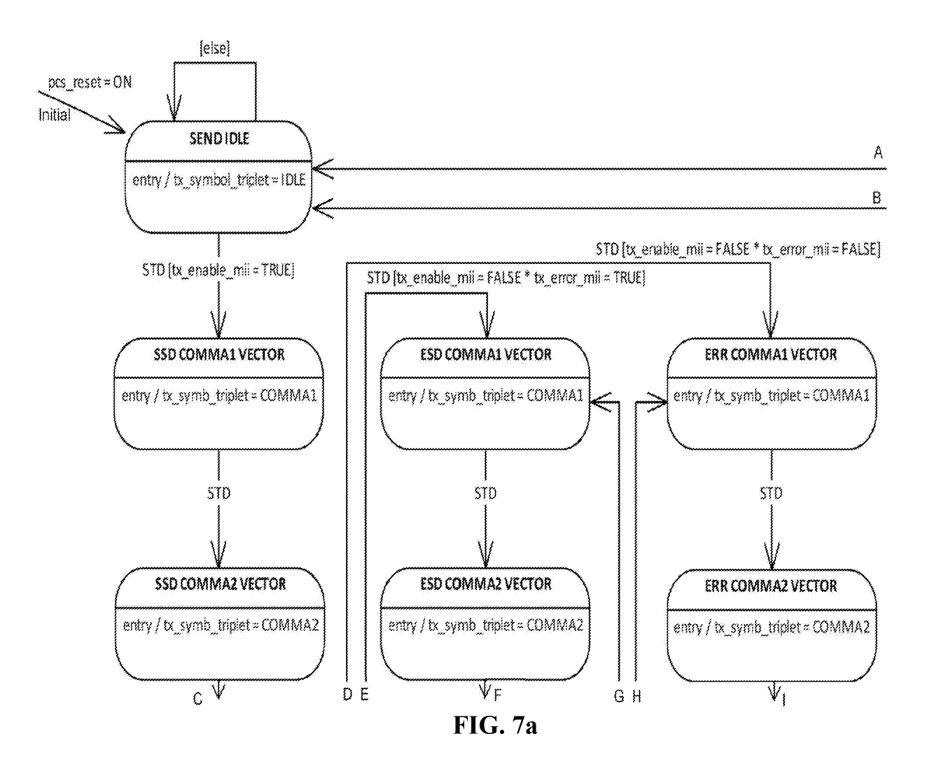

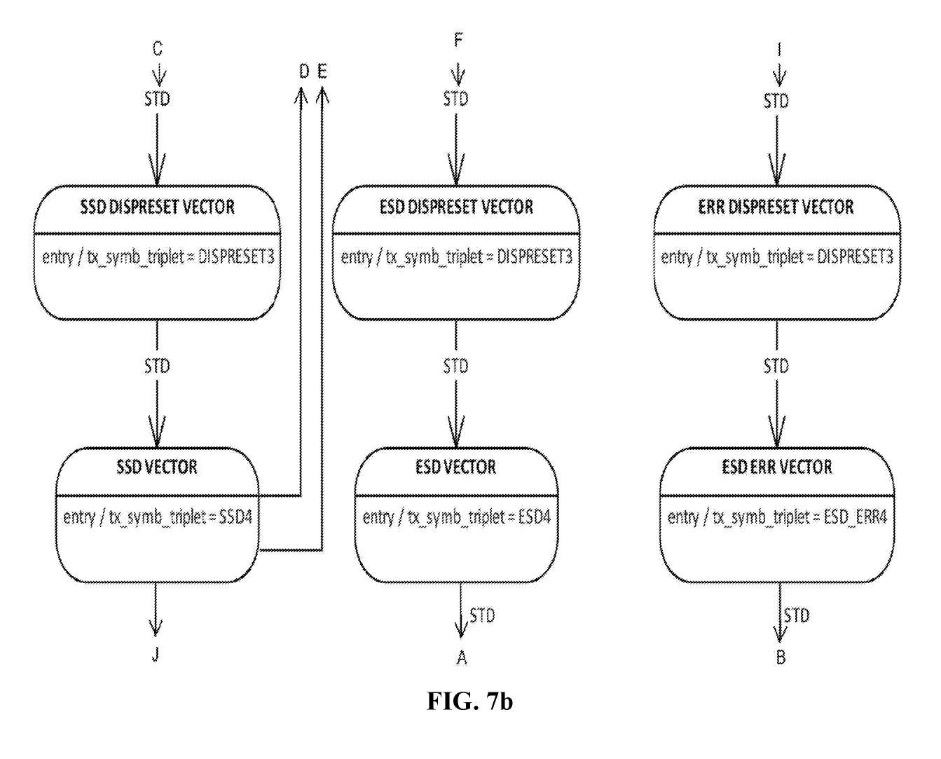

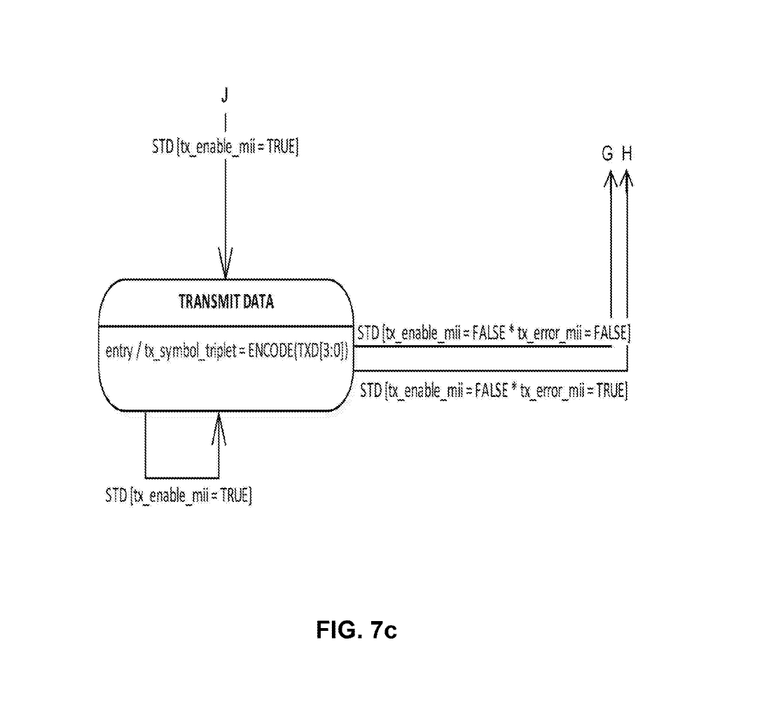

FIGS. 7a to 7c show a more detailed state diagram of the states that the PCS moves through during transmission of user data from the PHY;

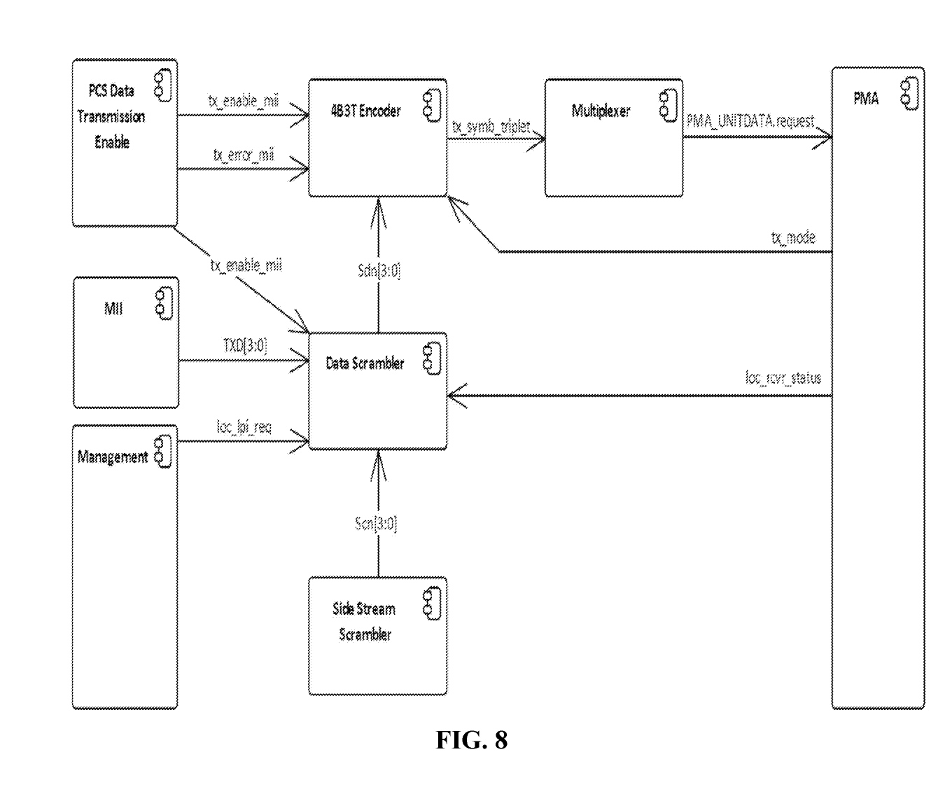

FIG. 8 shows a schematic block diagram of the blocks of the PHY concerned with data transmission;

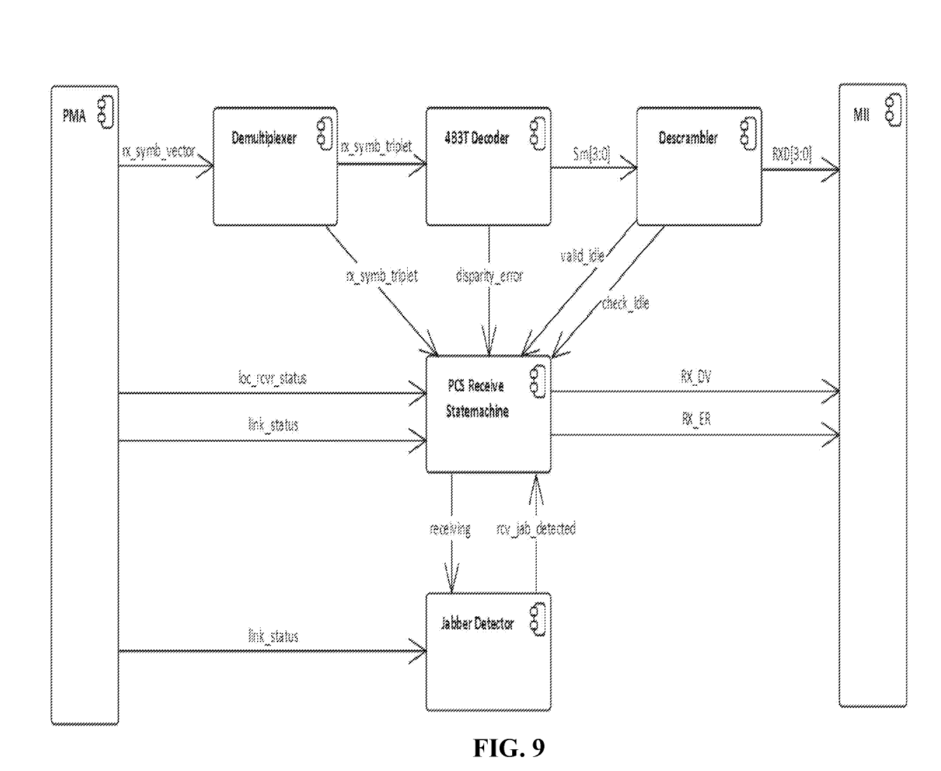

FIG. 9 shows a schematic block diagram of the PCS receiver of the PHY;

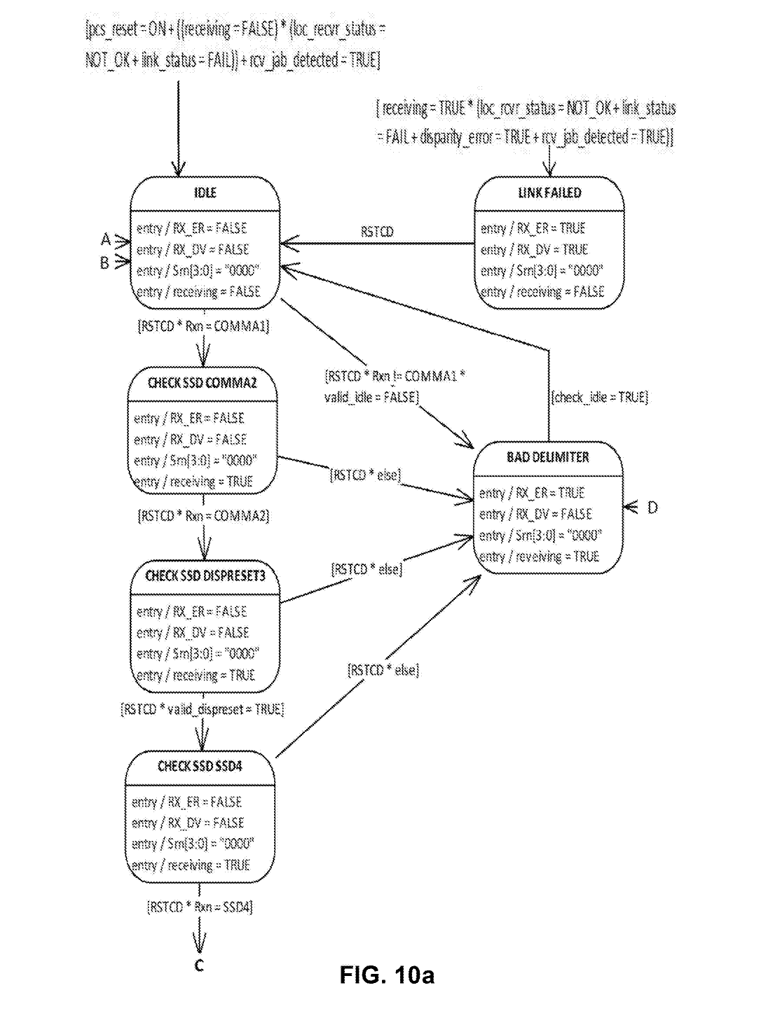

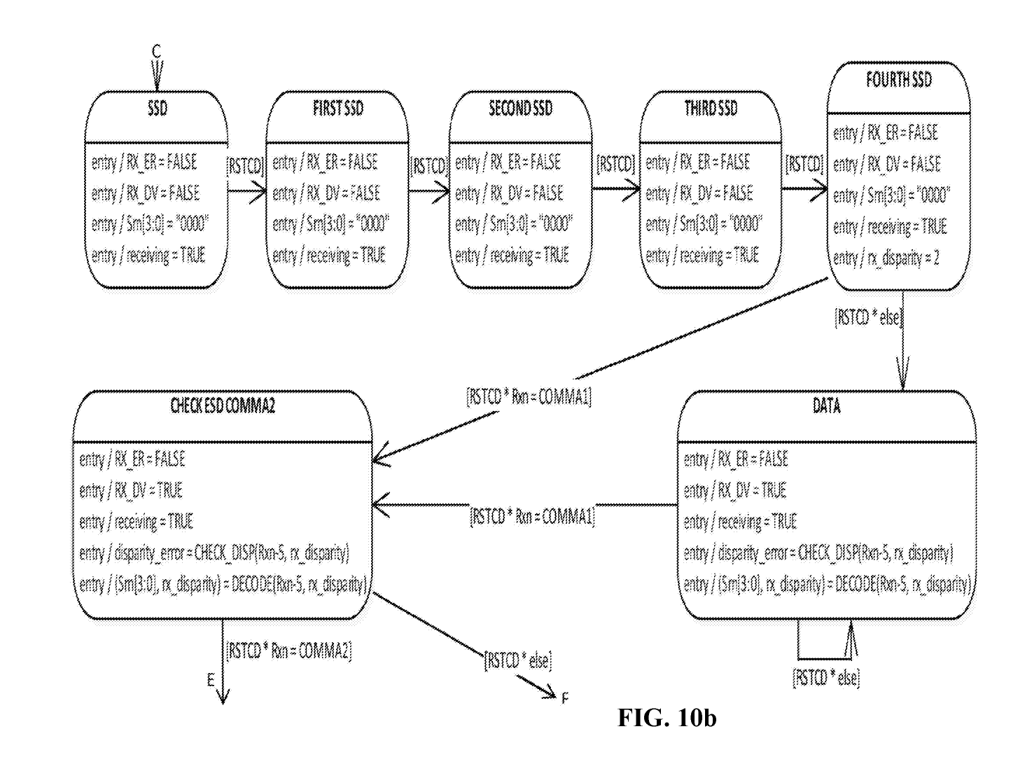

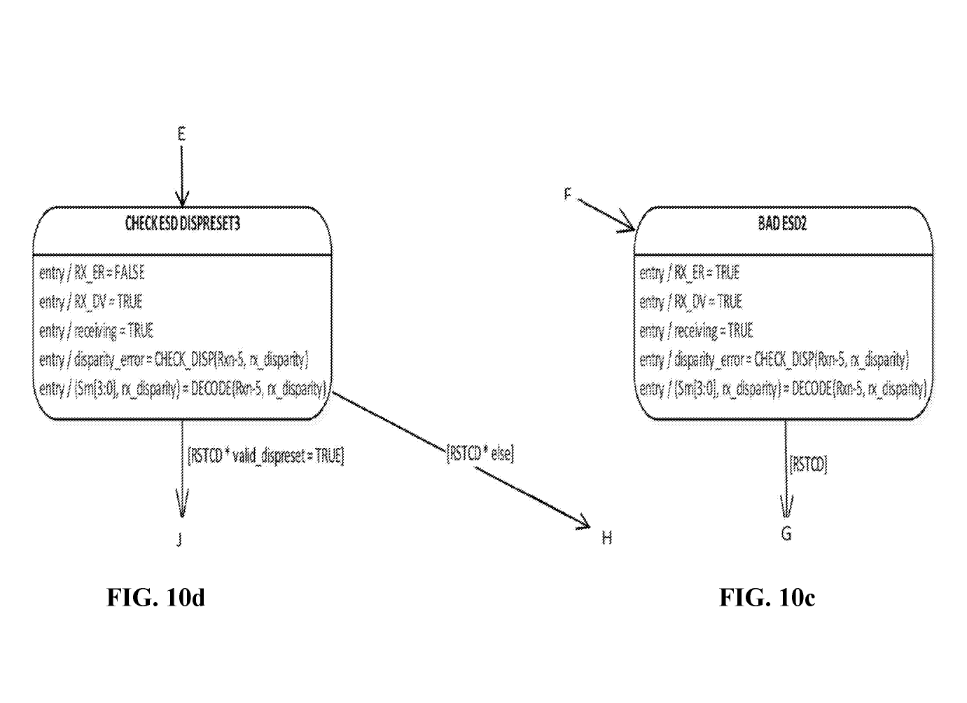

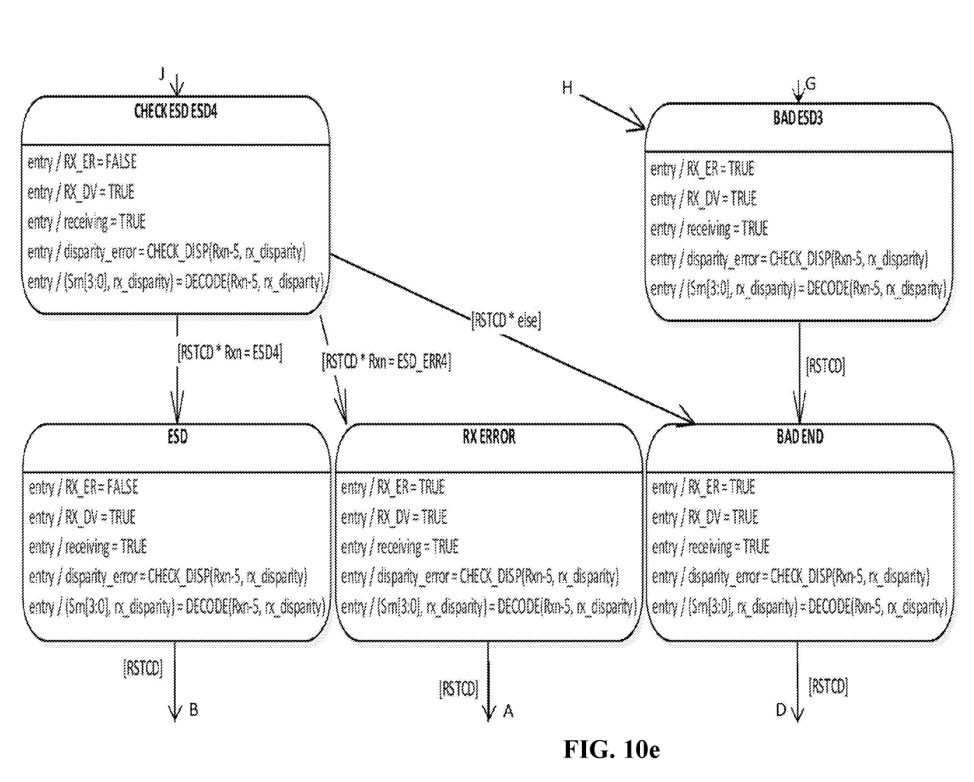

FIGS. 10a to 10e show schematic diagrams of a PCS receive state machine, for reception of data from the remote PHY; and

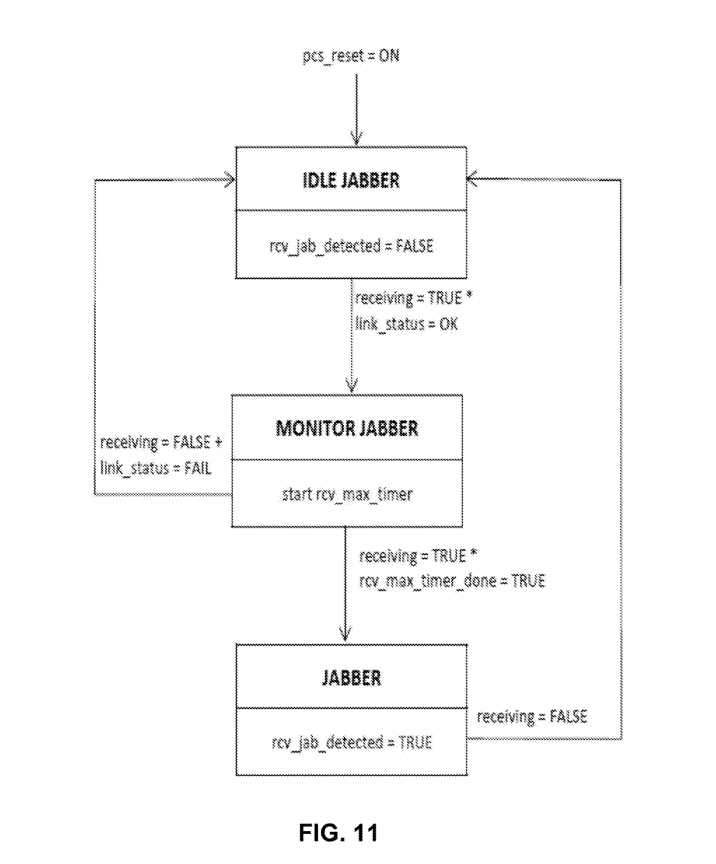

FIG. 11 shows a schematic diagram of a jabber detection state machine that is used for jabber detection.

The figures are not to scale, and same or similar reference signs denote same or similar features.

The schematic diagram of FIG. 1 shows a block diagram of a network port 10 comprising a pair of network terminals 12a and 12b. The pair of network terminals is for connecting to a pair of balanced conductors, such as a twisted pair of conductors of a network cable, or a balanced pair of conductors of a backplane. As shown, the network port 10 comprises a power supply 35 and a PHY 30 according to an embodiment of the invention. The power supply 35 supplies differential power to the pair of network terminals 12a and 12b, so that the power can be carried via the balanced pair of conductors to another similar, remote, network port which consumes the power, for example a network port of an Ethernet Powered Device.

The PHY 30 has two output contacts Pa and Pb for differential serial data, and the differential serial data is modulated onto the pair of network terminals 12a and 12b via a pair of signal coupling capacitors 31. The PHY has an internal terminating resistor (not shown in Figs), typically 100 ohms, connected across its outputs Pa and Pb, or a 50 ohm series resistor for each output Pa and Pb. The differential serial data is isolated from the power supply 35 by a coupled inductor 36, which blocks high frequency signals. According, the differential serial data can modulate the voltage that is applied across the pair of terminals 12a and 12b by the power supply 35. The network port 10 also comprises optional common-mode rejection (CMC) and optional electro-magnetic (EMC) protection for the pair of terminals 12a and 12b.

The PHY 30 both sends data to and receives data from the pair of network terminals 12a and 12b in full duplex, using differential signalling. The remote network port comprises a similar PHY to the PHY 30, for sending and receiving data to and from PHY 30. Each PHY typically receives digital data from a digital device, and modulates and sends the digital data as differential serial data over the pair of balanced conductors. Specifically, the digital data is received as a binary data stream at a media independent interface MII of the PHY, the binary data stream is converted into a ternary symbol stream at a Physical Coding Sublayer PCS of the PHY, and the ternary symbol stream is output as differential voltage signals at Pa and Pb by a Physical Medium Attachment Sublayer of the PHY.

In this embodiment, the power supply voltage is 12V, and the signal amplitude voltage across Pa and Pb is 1V peak-to-peak. Accordingly, the power supply 35 holds the network terminal 12a at a voltage of 12V above the voltage of the network terminal 12b, via the coupled inductor 36, and this voltage is modulated by the PHY 30. The PHY 30 has terminals Pa and Pb that output differential voltages of −0.5V, 0V, or +0.5V, corresponding to ternary symbols of −1, 0, or +1. The voltages at terminals Pa and Pa are coupled to the network terminals 12a and 12b via the signal coupling capacitors 31, and so modulate the power supply voltage applied by the power supply 35. Clearly, the values of the voltages may vary in alternative embodiments, or according to alternative operational modes.

The schematic diagram of FIG. 2a shows an example of a signal SIGa across the network terminals 12a and 12b, the signal SIGa resulting from the power supply voltage PWR from the power supply 35 and the ternary symbols output by the PHY 30 on top of the power supply voltage. The signal SIGa results from the PHY 30 applying several consecutive +1 symbols, followed by one −1 symbol, one +1 symbol, and one 0 symbol. The PHY 30 initially applies the first +1 symbol via the coupling capacitors 31 by transitioning upwards by a positive voltage x. This positive voltage is held for as long as the sequence of +1 symbols continues, and it can be seen that the SIGa voltage exponentially droops towards the power voltage PWR during this time, primarily because of charge passing through the coupled inductor 36 to the power supply 35. When the PHY applies the −1 symbol at time T1a, the signal transitions downwards by a voltage of 2x, and begins drooping up towards the power supply PWR, before being raised up by 2x when the PHY applies the +1 signal, and being reduced by x at time T2a when the PHY applies the 0 symbol.

The schematic diagram of FIG. 2b shows an example of a signal SIGb, which is the same as the signal SIGa, except for that it shows the voltage across the network terminals 12a and 12b when a reduced number of +1 symbols is transmitted consecutively compared to the number of +1 symbols transmitted consecutively in FIG. 2a. The PHY 30 initially applies the +1 symbol via the coupling capacitors 31 by transitioning upwards by a positive voltage x. This positive voltage is held for as long as the sequence of +1 symbols continues, and the SIGb voltage exponentially droops towards the power voltage PWR during this time. When the PHY applies the −1 symbol at time T1b, the signal transitions downwards by a voltage of 2x, and begins drooping up towards the power supply PWR, before being raised up by 2x when the PHY applies the +1 signal, and being reduced by x at time T2b when the PHY applies the 0 symbol.

The voltage of the signal SIGa at time T1a at the end of the sequence of +1 symbols, upon transition to the −1 symbol, is shown as Vpa, and the voltage of the signal SIGb at time T1b at the end of the (shorter) sequence of +1 symbols, upon transition to the −1 symbol, is shown as Vpb. It can be seen that the magnitude of Vpa is greater than Vpb, due to the greater amount of time that the signal voltage is allowed to droop for whilst the sequence of +1 symbols is being transmitted. Therefore, the higher the number of consecutive +1 (or −1) symbols transmitted, the more the signal voltage droops, and the further from the power supply voltage PWR the signal moves when the sequence of consecutive symbols ends. In theory, the signal voltage may move (overshoot) as far as 2x from the power supply voltage for an infinitely long sequence of consecutive +1 or consecutive −1 symbols, when the signalling voltage range is only x to −x.

This has implications for intrinsic safety, as the system has to be configured so that the voltage upon maximum amplitude (twice the signal voltage plus the power voltage) will still not exceed the maximum voltage allowed under the intrinsic safety requirements, limiting the signal voltage that can be used. Since limiting the maximum number of consecutive +1 or −1 symbols according to the present invention limits the maximum voltage that the signal voltage will move from the power supply voltage, a higher signalling voltage can be used without fear of breaking the maximum peak voltage allowed under intrinsic safety requirements. It also results in signal levels which are closer to their intended values and which are less susceptible to corruption by external noise.

The voltage of the signal SIGa at time T2a, upon transition to the 0 symbol, is shown as Zea, and the voltage of the signal SIGb at time T2b, upon transition to the 0 symbol, is shown as Zeb. It can be seen that the effects of the droop during the period of consecutive +1 symbols lasts beyond just the period of those symbols, and results in the voltage Zea being further from the power supply voltage PWR than the voltage Zeb. Ideally, the voltage Zea/Zeb would be equal to the power supply voltage, and limiting the maximum number of consecutive +1 or consecutive −1 symbols helps keep the voltage closer to the ideal voltage, reducing the voltage that the signal wanders from the ideal voltage, and extending the maximum distance that the signals can reliably be sent over.

The inductance of the coupled inductor 35, the capacitances of the capacitors 31, and the resistance of internal terminating resistor of the PHY govern the rate of droop, as will be apparent to those skilled in the art. The larger the inductor, the higher the inductor's resistance to charge leaking through it to the power supply, and the larger the capacitors, the more charge is transferred to the network terminals upon symbol transitions. Limiting the maximum number of consecutive +1 and consecutive −1 symbols to five will reduce the values of the inductor and capacitor that are required to prevent excessive droop, since the maximum amount of time that the droop can occur for is limited by the maximum allowed number of consecutive symbols at +1 and −1 values.

It will be understood that the diagrams of FIG. 2a and FIG. 2b only show the signals that are being transmitted from the network port 10 for the sake of clarity, and not the signal received from the remote network port, which would appear superimposed on the signals shown in FIGS. 2a and 2b.

The table of FIG. 3 shows one possible encoding scheme for limiting the number of consecutive +1 and consecutive −1 symbols to 5 symbols or less. The binary nibble is shown in the first column, the running disparity count is shown in the first row, and the ternary triplet used to represent the binary nibble for each running disparity count is shown in the cells of the table, along with the change in disparity incurred by that ternary triplet. Accordingly, the running disparity count is used to determine which one of the possible ternary triplets corresponding to each binary value is to be chosen for encoding.

For example if the binary value to be encoded is 0011, and the running disparity count is 2, then the table shows the ternary triplet to be encoded is 0, 0, +1, and that the running disparity count is increased by 1 to 3. If the binary value to be encoded is 0011, and the running disparity count is 4, then the table shows the ternary triplet is −1, −1, 0, and that the running disparity count is decreased by 2 to 2. Following this scheme, the maximum number of +1 symbols that can occur consecutively is 5, and the maximum number of −1 symbols that can occur consecutively is also 5. The running disparity is a running count of the sum of the values of the ternary symbols of the ternary symbol stream, and the encoding scheme converts the binary data stream into the ternary symbol stream in a manner that keeps the running count after each ternary triplet within a predetermined maximum range, of 1 to 4.

This coding scheme is just one example of a possible coding scheme, and may be modified if desired whilst keeping the maximum allowed number of consecutive positive symbols or consecutive negative symbols of the ternary symbol stream to 5 symbols or less.

At the start or end of each sequence of binary data received at the MII to be transmitted by the PHY, the PHY resets the running disparity to a predefined value, in this embodiment 2. This is done by taking the current disparity count, and inserting a ternary triplet DISPRESET3 to bring the running disparity back to 1, as shown in the table of FIG. 4. For example, if the current running disparity is 3, then the PCS inserts a DISPRESET3 ternary triplet of −1, 0, −1 into the ternary symbol stream, to reduce the running disparity by 2, down to 1. The ternary triplet DISPRESET3 is followed by a stream delimiter in the form of one of three ternary triplets, SSD4, ESD4, or ESD_ERR4. Each of SSD4, ESD4, and ESD_ERR4 has a disparity of 1, making the running disparity 2 given that the running disparity is always 1 after the ternary triplet DISPRESET3.

The ternary triplet SSD4 is chosen to delimit the beginning of user data being sent on the ternary symbol stream, the ternary triplet ESD4 is chosen to delimit the end of user data being sent on the ternary symbol stream, and the ternary triplet ESD_ERR4 is chosen to delimit the end of user data being sent on the ternary symbol stream if an error has occurred. The symbols making up each one of those ternary triplets are shown in FIG. 5.

Since the running count of the disparity is set to 2 at the beginning and end of each sequence of user data that is transmitted, the other PHY at the receiving end can count the disparity of the received signals from the SSD4 to the ESD4 to check that no errors have occurred during the transmission of the signal. The symbols that represent the delimiters are chosen, so that a single symbol error (conversion one of the symbols within the delimiter to the neighboring symbol, for example a +1 to a 0 or a −1 to a 0) still allows detection of the correct delimiter. This makes the delimiters more robust than the normal data, which is desirable since the delimiters are used for data synchronization. For one of the delimiters shown in FIG. 5 to be corrupted to a different one of those delimiters, two of the symbols of the delimiter would need to be corrupted.

Each DISPRESET3 ternary triplet and its subsequent stream delimiter may be prefaced by an escape sequence, to provide a clear indication to the receiving PHY that the subsequent symbols relate to a stream delimiter. In this embodiment, the escape sequence is formed of two COMMA ternary triplets (COMMA1 and COMMA2), each COMMA ternary triplet having symbols of 0, 0, 0. This sequence of six zeros breaks the coding scheme shown in FIG. 3, and so provides an unambiguous indication to the receiving PHY that a stream delimiter is about to be received. Alternatively, only one COMMA ternary triplet could be used instead of two COMMA ternary triplets.

The schematic diagram of FIG. 6 shows a state diagram for the PCS of the PHY, governing the transmission of user data from the PHY. The PCS receives a signal TX_EN from the MII, signalling that user data in the binary data stream from the MII is to be transmitted by the PHY. The variables defined in the state diagram are as follows:

link_status: The link_status parameter set by PMA Link Monitor.

### Values: OK or FAIL.

pcs_reset: The pcs_reset parameter set by the PCS Reset function.

### Values: ON or OFF.

tx_enable_mii: The tx_enable_mii variable is generated in the PCS Data Transmission Enable state diagram as specified in FIG. 6. When set to FALSE transmission is disabled, when set to TRUE transmission is enabled.

### Values: TRUE or FALSE.

tx_error_mii: The tx_error_mii variable is generated in the PCS Data Transmission Enable state diagram as specified in FIG. 6. When this variable is set to FALSE it indicates a non-errored transmission, when set to TRUE it indicates an errored transmission.

### Values: TRUE or FALSE.

TX_EN: The TX_EN signal of the MII.
TX_ER The TX_ER signal of the MII.
tx_mode The tx_mode parameter set by the PMA PHY Control function.

### Values: SEND_Z, SEND_N, or SEND_I.

When tx_mode is equal to SEND_N, the signals tx_enable_mii and tx_error_mii are equal to the values of the MII signals TX_EN and TX_ER respectively, otherwise tx_enable_mii and tx_error_mii are set to the value FALSE.

The PCS moves through this state diagram each time a chunk of user data is received and transmitted by the PHY. The PHY 30 supports both normal operation and link training operation. In training operation, the PCS ignores signals from the MII and sends only the idle signals to the PMA until training process is complete (signalled by the receiver). The training process usually includes triplet boundary synchronization, descrambler lock, polarity detection, timing acquisition, echo cancellation and equalizer convergence and so on. If tx_mode has the value SEND_Z, PCS Transmit passes a vector of zeros at each symbol period to the PMA. If tx_mode has the value SEND_I, PCS Transmit generates sequences of symbols according to an encoding rule in training mode.

If tx_mode has the value SEND_N, PCS Transmit generates ternary symbols Aₙ at each symbol period representing data, and special control symbols like SSD/ESD as defined later. The transition from idle data to user data is signalled by an SSD, and the end of transmission of data is signalled by an ESD. During training operation (when tx_mode is SEND_I), knowledge of the transmitted symbols may be used at receiver side to perform any signal conditioning necessary for meeting the required performance during normal operation. When the link is up, the PHY enters SEND_N mode and the transmitted ternary symbols are used at the receiving PHY for continued clock frequency/phase tracking.

A more detailed state diagram of states that the PCS moves through during transmission of user data is shown in the schematic diagrams of FIGS. 7a to 7c. The PCS Transmit function conforms to this state diagram in FIGS. 7a to 7c, and the associated state variables, functions, timers and messages. In each symbol period, PCS Transmit generates a symbol Aₙ provided to the PMA, operating in one of three different modes (tx_mode), where symbol Aₙ is a ternary code that can take values of {−1, 0, +1}. The PMA transmits symbol Aₙ over the balanced pair of conductors via the coupling capacitors 31. The integer, n, is a time index, introduced to establish a temporal relationship between different symbol periods. A symbol period, T, is nominally equal to 133.333 ns.

Upon a reset, the PCS begins in the state SEND IDLE, where idle data is sent by the PHY. The idle data is continuously provided in the ternary symbol stream to the PMA to help maintain the data link, even during long periods when no user data is required to be sent. The idle data that is sent in the Idle state can be used to communicate information on the status of the receiver of the PHY, to the other PHY, the information for example signalling whether the PHYs need to be retrained, or providing an idle or wake indication for implementing Energy Efficient Ethernet (EEE).

When tx_enable_mii is set to TRUE, indicating that user data is to be sent, the PHY sends the COMMA1 and COMMA2 ternary triplets as an escape sequence to signal to the receiver that user data is about to be sent, followed by a DISPRESET3 ternary triplet to reset the running disparity of the ternary triplet stream to 1, and an SSD4 ternary triplet to delimit the start of the user data, as shown in the first column of states in the state diagram of FIGS. 7a to 7c. The state machine then moves to the TRANSMIT DATA state whilst the user data is transmitted. Accordingly, upon the assertion of TX_EN by the MII, the PCS Transmit function passes 12 consecutive ternary symbols to the PMA, which replace the first 16 bits of the preamble. Following these symbols, TXD[3:0] is encoded into ternary symbols using the encoding rules (FIG. 3) until TX_EN is de-asserted.

Following the de-assertion of TX_EN by the MII, 12 consecutive symbols including a special code ESD (or ERR_ESD when a transmit error is encountered) are generated, after which the transmission of idle mode data can be resumed. Specifically, once tx_enable_mii is set to FALSE, indicating that transmission of user data is ending, the PCS outputs two COMMA ternary triplets as an escape sequence to signal to the receiver that user data is ending, followed by a DISPRESET3 ternary triplet to reset the running disparity of the ternary triplet stream to 1, and an ESD4 or ESD_ERR4 ternary triplet to delimit the end of the user data.

At the end of a frame, it is examined, if TX_ER was high at any point during the transmission, to determine whether ESD4 or ERR_ESD4 is to be transmitted following COMMA1, COMMA2 and DISPRESET3. Specifically, if there were no errors during user data transmission, as signalled by tx_error_mii=FALSE, then the state machine follows the second column of states shown in the state diagram of FIGS. 7a to 7c to give the ESD4 ternary triplet. If there was an error during user data transmission, as signalled by tx_error_mii=TRUE, then the state machine follows the third column of states shown in the state diagram of FIGS. 7a to 7c to give the ESD_ERR4 ternary triplet instead of the ESD4 ternary triplet, to signal to the receiver that the sent data was erroneous.

A schematic block diagram showing the blocks of the PHY 30 concerned with data transmission is shown in FIG. 8. It can be seen that the binary data stream TXD[3:0] is received at the MII, and passed to the data scrambler for scrambling. The scrambled binary data stream is then passed to the encoder, where it is encoded into ternary symbols. The three ternary symbol generated for each binary nibble are multiplexed together into a single symbol stream by a multiplexer, and then sent to the PMA for sending on the pair of balanced conductors.

The ternary symbols of each triplet of ternary symbols are generated by the encoder in parallel with one another at a rate of 1/3 of a symbol rate of the ternary symbol stream, and the ternary symbols of each triplet are multiplexed into the ternary symbol stream at the symbol rate of the ternary symbol stream. In this particular embodiment, the triple ternary symbols are created at a frequency of 2.5 MHz, the multiplexed ternary symbol stream is transmitted along the balanced pair of conductors at a symbol rate of 7.5 MSymbols/s.

The encoder comprises a control sequence generator block (not shown in Figs) and a symbol mapping block (not shown in Figs), the control sequence generator block outputting control codes such as the COMMA1, COMMA2, DISPRESET3, ESD4, and ESD_ERR4 ternary symbols to the multiplexer, and the symbol mapping block outputting ternary symbols corresponding to data received in the binary data stream. The blocks keep track of the running disparity of the symbols that are generated.

The side stream scrambler generates a pseudorandom stream that is used in the data scrambler to scramble the binary data stream from the MII. The side stream scramblers for the local and remote PHYs are different to one another to make their simultaneous transmissions on the balanced pair of conductors more easily distinguishable from one another. In this particular embodiment, the side-stream scramblers are implemented by linear-feedback shift registers. The bits stored in the shift register delay line at time n are denoted by Scrₙ[32:0]. At each symbol period, the shift register is advanced by one bit, and one new bit represented by Scrₙ[0] is generated. The side-stream scrambler is reset upon execution of the PCS Reset function, with all bits of the 33-bit vector being reset, but not to all zeros as will be apparent to those skilled in the art. The side stream scrambler of the master PHY can be described by the generator polynomial g_{M}(x)=1+x¹³+x³³, and the side stream scrambler of the slave PHY can be described by the generator polynomial g_{S}(x)=1+x²⁰+x³³, so the side stream scramblers of the master and slave PHYs are statistically independent, and provide statistically independent data streams from one another.

The side stream scrambler is used to generate four bits Scₙ[3:0], which are used to scramble the data word TXD[3:0] from the MII during data transmission, and to generate the idle data. These four bits Scₙ[3:0] are generated using an auxiliary generating polynomial, g(x)=x³\hat{ }x⁸, according to the following equations:

Scₙ[0]=Scrₙ[0]

Scₙ[1]=g(Scrₙ[0])=Scrₙ[3]\hat{ }Scrₙ[8]

Scₙ[2]=g²(Scrₙ[0])=Scrₙ[6]\hat{ }Scrₙ[16]

Scₙ[3]=g³(Scrₙ[0])=Scrₙ[9]\hat{ }Scrₙ[14]\hat{ }Scrₙ[19]\hat{ }Scrₙ[24]

By construction, the four bits Scₙ[3:0] are derived from elements of the same maximum-length shift register sequence of length 2³³⁻¹ as Scrₙ[0], but shifted in time by varying delays. The associated delays are all large and different so that there is no apparent correlation among the bits.

From the scrambler bits Scₙ[3:0] and the data bits TXDₙ[3:0] from the MII, bits Sdₙ[3:0] are generated as follows:

$${Sd}_{n} [ 3 ] = \{ \begin{matrix}{{Sc}_{n} [ 3 ]}^{⋀} {TXD}_{n} [ 3 ] & if ( tx\_enable \_mii = TRUE ) \\ {{Sc}_{n} [ 3 ]}^{⋀} 1 & else if ( loc\_rcvr \_status = OK ) \\ {Sc}_{n} [ 3 ] & else\end{matrix} \\ {Sd}_{n} [ 2 ] = \{ \begin{matrix}{{Sc}_{n} [ 2 ]}^{⋀} {TXD}_{n} [ 2 ] & if ( tx\_enable \_mii = TRUE ) \\ {{Sc}_{n} [ 1 ]}^{⋀} 1 & else if ( loc\_lpi \_req = TRUE ) \\ {Sc}_{n} [ 1 ] & else\end{matrix} \\ {Sd}_{n} [ 1 \text{:} 0 ] = \{ \begin{matrix}{{Sc}_{n} [ 1 \text{:} 0 ]}^{⋀} {TXD}_{n} [ 1 \text{:} 0 ] & if ( tx\_enable \_mii = TRUE ) \\ ( {Sc}_{n} [ 2 ] {Sc}_{n} [ 0 ] ) & else\end{matrix}$$

The loc_rcvr_status is a parameter set by the receiver of the PHY, to indicate the status of the receiver, and has a value of OK or NOT_OK. The loc_lpi_req is a parameter that is set to TRUE, if low power idle mode is requested. During transmission of idle data, bits Scₙ[1] and Scₙ[2] are swapped compared to user data transmission, which can be used to reliably distinguish idle data transmission from data transmission on the receiver side. The scrambled bits Sdₙ[3:0] are converted to a ternary triplet tx_symb_triplet by the encoder.

The PCS of the PHY 30 includes both the transmit and receive functions of the PHY. The PCS interfaces with the MII for sending and receiving of binary data, and the PCS interfaces with the PMA for sending and receiving of ternary symbols on the pair of balanced conductors. The PCS includes a PCS data transmission enable function for generating the tx_error_mii and tx_enable_mii flags from the TX_EN and TX_ER signals received from the MII.

The data TXD<3:0> in the binary data for transmission is received from the MII, and a ternary symbol stream tx_symb_vector is sent to the PMA for transmission over the balanced pair of conductors. The PMA receives ternary symbols on the balanced pair of conductors from the other PHY, and passes these symbols in a further ternary symbol stream rx_symb_vector to the PCS receive function. The PCS receive function converts the further ternary symbol stream back to a binary data stream RXD<3:0>, which is output to the MII.

The schematic diagram of FIG. 9 shows a block diagram of the PCS receiver of the PHY 30. The further ternary symbol stream rx_symb_vector is received from the PMA, and is de-multiplexed into triple ternary groups of symbols rx_symb_triplet that are sent to the decoder and PCS receive state machine. The decoder reverses the encoding of the data performed by the encoder of the other PHY, to provide a binary data stream Srₙ[3:0], and this is descrambled by the descrambler to provide a further binary data stream RXD[3:0] to the MII.

When PMA of the PHY 30 indicates normal operation and sets loc_rcvr_status=OK, the PCS receive function checks the symbol sequences and searches for SSD or receive error indicators. To achieve correct operation, PCS receiver uses the knowledge of the encoding rules that are employed in the idle mode (the triplet (0, 0, 0) will never occur, if this triplet is being received, then the symbol synchronization in the de-interleaving block needs to be adjusted).

The PCS receiver generates the sequence of symbols and indicates the reliable acquisition of the descrambler state by setting the parameter scr_status to OK. The received ternary triplets rx_symb_triplet are decoded to generate signals RXD[3:0], RX_DV, and RX_ER at the MII. The decoder also generates a disparity_error signal for the PCS receive state machine when a ternary triplet is received that is not allowed according to the current running disparity value. Each time a ternary triplet is received, the running disparity is updated. This is done using the current running disparity and adding the disparity change value as specified in FIG. 3 for the currently received ternary triplet.

The PCS receiver sets RX_DV=TRUE when it receives an SSD delimiter, and sets RX_DV=FALSE when it receives ESD delimiter or an ESD with error delimiter. The PCS receiver sets RX_ER=TRUE when it receives bad ESDs, ERR_ESD, or bad SSDs. When the PCS receive state machine reaches an IDLE state, RX_ER gets reset to FALSE. The PCS receive state machine is shown spread across FIGS. 10a to 10e. When the PCS is reset, the receiver begins in the IDLE state, and awaits receipt of a correct SSD sequence. Then, data is received in a data state, until an ESD sequence is received. There are various functions that are performed to determine the movement of the PCS receiver through the various states of the PCS state machine, as shown in FIGS. 10a to 10e. The following variables and functions are used:

valid_idle: This function checks whether or not the decoded data bits Srₙ[1:0] are equal to the expected Sdₙ[1:0] values from the local descrambler. Srₙ[3] cannot be used for comparison since it carries rem_rcvr_status and Srₙ[2] cannot be used in comparison since it carries rem_lpi_req.

check_idle: The check_idle function indicates a reliable detection of the idle data stream.

### Values: TRUE or FALSE.

valid_dispreset: The rx_symb_triplet is one of the DISPRESET3 triplets as specified in FIG. 4. It returns a Boolean value indicating whether or not one of the four DISPRESET3 triplets has been received.
DECODE: In the PCS receive process, this function takes as its arguments the value of rx_symb_triplet and rx_disparity and returns the corresponding Srₙ[3:0] as well as the updated rx_disparity.
CHECK_DISP: The CHECK_DISP function checks, if the currently received triple ternary symbol is allowed for the current rx_disparity.

A timer is used to determine the maximum amount of time the PHY receive state machine stays in the DATA state. For example, the timer may be set to expire after around 2 ms, allowing sufficient time for transmission of 1500 bytes at 10 Mbps. The condition rcv_max_timer done becomes true upon timer expiration.

A jabber detection state machine is used to prevent any mis-detection of ESD1 that would make the PCS Receive state machine lock up in the DATA state. The maximum dwelling time in the DATA state shall be less than the period specified for rcv_max_timer. When rcv_max_timer expires, the PCS Receive state machine is reset and transition to IDLE state is forced. A schematic diagram of the jabber detection state machine is shown in FIG. 11, and a variable rcv_jab_detected is set as TRUE when jabber is detected, otherwise it is set to FALSE. Jabber detection refers to the detection of a data frame that is greater than the maximum frame size allowed, as will be apparent to those skilled in the art.

Referring back to FIG. 9 again, the descrambler descrambles the data stream Srₙ[3:0] and returns RXD[3:0] to the MII. For side-stream descrambling, the Master PHY employs the following receiver descrambler generator polynomial: g′_{M}(x)=1+x²⁰+x³³, and the Slave PHY employs the following receiver descrambler generator polynomial: g′_{S}(x)=1+x¹³+x³³.

The descrambler of the slave PHY is synchronized to the scrambler of the master PHY using the idle data sent by the master PHY, and then the descrambler of the master PHY is synchronized to the scrambler of the slave PHY using the idle data sent by the slave PHY. The PHY receiver of both the master and slave PHYs provides automatic polarity detection and correction. Polarity can be automatically detected in a recursive process: one assumption of polarity is made first and the descrambler synchronization is monitored within a certain period to determine whether such an assumption is correct; if not, the same procedure is repeated with a different polarity assumption and vice versa.

Receiver polarity detection and correction can be done simultaneously at the earliest link up stages. Link up starts with the Master PHY sending symbols to the Slave PHY. If a polarity flip is detected, the Slave PHY changes the sign of its received symbols to correct the polarity. There is no change in the polarity of the transmit signal. After the Slave PHY has started transmission, the Master PHY can use the same method for determining its receive polarity.

The PCS may be placed in loopback mode where the PCS accepts data on the transmit path from the MII and returns it on the receive path to the MII. Additionally, the PHY receive circuitry is isolated from the network medium, and the assertion of TX_EN at the MII does not result in the transmission of data on the network medium. Then, the packets sent through the MII Transmit function can be compared to the packets received from the MII Receive function to validate the functionality of the PCS.

Many other variations of the described embodiments falling within the scope of the invention will be apparent to those skilled in the art.

1. A method for supporting full duplex communication between a local PHY and a remote PHY via a single balanced pair of conductors, wherein the local PHY and the remote PHY are Ethernet PHYs, the method comprising for each PHY receiving at a Physical Coding Sublayer (PCS) of the PHY a binary data stream from a Medium Independent Interface (MII) of the PHY, converting the binary data stream into a ternary symbol stream within the PCS, and providing the ternary symbol stream to a Physical Medium Attachment Sublayer (PMA) of the PHY for transmission of the ternary symbol stream over the balanced pair of conductors, using 3-level Pulse Amplitude Modulation (PAM-3), wherein the conversion comprises:
converting each nibble of the binary data stream directly into one respective triplet of ternary symbols for the ternary symbol stream, and
limiting a maximum allowed number of consecutive positive symbols or consecutive negative symbols of the ternary symbol stream to 5 symbols or less.

2. The method of claim 1, comprising generating the ternary symbols of each triplet of ternary symbols in parallel with one another at a rate of 1/3 of a symbol rate of the ternary symbol stream, and multiplexing the ternary symbols of each triplet into the ternary symbol stream at the symbol rate of the ternary symbol stream.

3. The method of claim 1, comprising continuously providing the ternary symbol stream to the PMA even when user data is not being transmitted by the PHY, wherein the ternary symbol stream contains data received from the MII while transmitting user data, and contains idle data while not transmitting user data.

4. The method of claim 3, comprising scrambling the binary data stream which contains the user data and the idle data using a side stream scrambler, before converting the nibbles of the binary data stream into the ternary symbol stream, further comprising synchronising a descrambler of the remote PHY to the side stream scrambler of the local PHY using the idle data, and detecting whether the descrambler is in synchronisation with the side stream scrambler.

5. The method of claim 4, wherein the local and remote PHYs each comprise an adaptive echo canceller and an adaptive equaliser, and wherein two independent scrambler polynomials are used for the side stream scrambler of the local PHY and the side stream scrambler of the remote PHY, to provide statistically independent data streams for both PHYs and allow separate training of the echo canceller and equaliser of each PHY.

6. The method of claim 3, comprising communicating information on a status of a receiver of the local PHY to the remote PHY in the idle data, the information signalling whether the PHYs need to be retrained.

7. The method of claim 3, comprising inserting stream delimiters into the ternary data stream between the user data and the idle data, to differentiate between the user data and the idle data.

8. The method of claim 7, wherein the stream delimiters comprise:
a start delimiter that is inserted before the start of the user data;
an end delimiter that is inserted at the end of the user data if no indication of an error is received from the medium independent interface (MII); and
an end delimiter with error that is inserted at the end of the user data if an indication of an error has been received from the medium independent interface (MII).

9. The method of claim 7, wherein inserting each stream delimiter into the ternary symbol stream comprises replacing three successive ternary symbols of the ternary bit stream with three ternary symbols having values indicating a type of the stream delimiter.

10. The method of claim 7, comprising inserting each stream delimiter as a plurality of symbols in the ternery symbol stream, wherein the plurality of symbols are still uniquely identifiable as the stream delimiter even if the value of one of the plurality of symbols is altered from a +1 or −1 value to a zero value, or if the value of one of the plurality of symbols is altered from the zero value to the +1 or −1 value.

11. The method of claim 8, comprising signalling a beginning of each stream delimiter by inserting an escape sequence into the ternary symbol stream before the stream delimiter, wherein the escape sequence comprises at least three successive ternary symbols all having the value of zero.

12. The method of claim 11, wherein inserting the escape sequence into the ternary symbol stream comprises replacing six successive ternary symbols of the ternary bit stream with six ternary symbols having the value of zero.

13. The method of claim 1, comprising keeping a running count of the sum of the values of the ternary symbols of the ternary symbol stream, converting the binary data stream into the ternary symbol stream to keep the running count within a predetermined maximum range, and determining that an error has occurred if the running count of the ternary symbols of a received further ternary symbol stream exceeds a specified maximum range, to provide detection of communication errors under high noise conditions.

14. The method of claim 1, comprising the PCS receiving a further ternary symbol stream from the PMA of the PHY, the further ternary symbol stream containing data received from the balanced pair of conductors.

15. The method of claim 14, comprising reversing a polarity of the further ternary symbol stream if correct polarity is not detected, without reversing a polarity of the ternary symbol stream that is being transmitted.

16. The method of claim 15, comprising detecting correct polarity by attempting to synchronize the descrambler, and if a descrambler lock is not reached within a predetermined period of time, reversing the polarity of the further ternary symbol stream.

17. The method of claim 14, comprising using the ternary symbols of the further ternary symbol stream for clock frequency and/or phase tracking.

18. The method of claim 1, comprising creating the triple ternary symbols at a frequency of 2.5 MHz and transmitting the multiplexed ternary symbol stream along the balanced pair of conductors at a symbol rate of 7.5 MSymbols/s.

19. The method of claim 1, wherein:
each PHY is connected to the balanced pair of conductors by capacitive impedances, and the method comprises transmitting the ternary symbol stream on the balanced pair of conductors via the capacitive impedances; and
each PHY is comprised in a device, wherein the device also comprises power circuitry connected to the balanced pair of conductors by inductive impedances, and wherein the method comprises sending power from the device having the local PHY to the device having the remote PHY via the inductive impedances and the balanced pair of conductors.

20. The method claim 1, wherein the local and remote PHYs support full duplex communication at a data rate of 10 Mb/s, at a range of at least 1 km over the balanced pair of conductors.
